(19) United States
(12) Patent Application Publication
(10) Pub. No.: US 2025/0228258 A1
(43) Pub. Date: Jul. 17, 2025

(54) PRESERVED FOOD PRODUCT AND PRESERVATION COMPOSITION

(71) Applicant: PURAC BIOCHEM B.V., Gorinchem, (NL)

(72) Inventors: Catalin IANCU, Gorinchem (NL); Gijsbertus Theodorus Cornelis Antonius LOMMERSE, Gorinchem (NL); Laura VILCHES BAZAGA, Gorinchem (NL)

(21) Appl. No.: 18/405,639

(22) PCT Filed: Jul. 6, 2022
(86) PCT No.: PCT/EP2022/068777

§ 371 Date: Jan. 5, 2024

(30) Foreign Application Priority Data
Jul. 6, 2021 (EP) 21183990.7

(51) Int. Cl. A23B 2/754; A23B 4/12

(52) U.S. Cl. CPC A23B 2/754; A23B 4/12

(57) ABSTRACT

The present invention provides a preserved food product comprising a ferulic acid component and an organic acid component in a molar ratio of at least 0.1, the ferulic acid component being selected from ferulic acid, ferulate and combinations thereof; and the organic acid component being selected from acetic acid, acetate, lactic acid, lactate, propionic acid, propionate and combinations thereof; wherein
(i) the ferulic acid component and the organic acid component are homogeneously distributed throughout the preserved food product and said food product contains per kg of food product 3.6-75 mmol of the ferulic acid component and 10-200 mmol/kg of the organic acid component; or
(ii) the surface of the food product contains 3.6-75 mmol per kg of the ferulic acid component and 10-200 mmol per kg of the organic acid component, the surface of the food product being defined as the outside layer of the food product having a thickness of 0.5 mm.

The inventors have found that bacterial spoilage of food products can be delayed very effectively by using a combination of ferulic acid component and organic acid component in carefully balanced concentrations.

### CROSS-REFERENCE TO RELATED APPLICATIONS

This application is a continuation of International Patent Application No. PCT/EP2022/068777 filed Jul. 6, 2022, which application claims priority to Netherlands patent application Ser. No. 21/183,990.7 filed Jul. 6, 2021, the contents of which are both incorporated herein by reference in their entireties.

### FIELD OF THE INVENTION

This invention relates to a preserved food product that shows increased resistance against bacterial spoilage, especially bacterial spoilage caused by lactic acid producing bacteria and pathogenic bacteria such as Listeria.

A method of preparing the preserved food and the use of a preservative composition for preserving food products are also part of the invention.

### BACKGROUND OF THE INVENTION

Food spoilage may be defined as any change that renders food unfit for consumption. These changes may be caused by various factors, including contamination by microorganisms, infestation by insects, or degradation by endogenous enzymes. In addition, physical and chemical changes, such as the tearing of plant or animal tissues or the oxidation of certain constituents of food, may promote food spoilage.

Foods may be contaminated by microorganisms at any time during harvest, storage, processing, distribution, handling, or preparation. The primary sources of microbial contamination are soil, air, animal feed, animal hides and intestines, plant surfaces, sewage, and food processing machinery or utensils. Bacteria are among the principal microorganisms that cause food spoilage.

The most common methods used either to kill or to reduce the growth of microorganisms are the application of heat, the removal of water, the lowering of temperature during storage, the reduction of pH, the control of oxygen and carbon dioxide concentrations, the removal of the nutrients needed for growth and the addition of preservatives. Commonly used antimicrobial preservatives include sorbic acid, sorbates, benzoic acid, benzoates, nitrites, nitrates, lactic acid, lactates, propionic acid, propionates, acetic acid (vinegar) and acetates.

Lactic acid bacteria are facultative anaerobic bacteria, which means that they tolerate oxygen, but thrive without air. This group of bacteria can play a positive role in the food industry and account for some special tastes-like fermenting pickles or sauerkraut, for example—but they can also cause major spoilage, hurting customers' perception of a brand or product. Consumers expect food to have a long shelf life and enjoy the convenience of products that can keep for an extended period of time. From a commercial point of view, this is also important given the fact that considerable time can elapse in light of transportation logistics and storage before a product is consumed.

Foods that have low pH or are vacuum-packed, such as salad dressings, tomato-based products and processed meats, are particularly susceptible to spoilage from lactic acid bacteria. These need to be carefully monitored to help avoid contamination. Undesirable spoilage caused by lactic acid bacteria includes a.o. greening of meat, gas formation in cheese, bloating or exploding of vacuum sealed pouches, off flavors (cheesy, malty, acidic, foul, sour), slime on meats, ropy beverages or dairy.

Lactic acid bacteria are considered quality indicators since conditions favorable to their growth also favor growth of pathogenic bacteria, e.g. Clostridium botulinum, which is a dangerous bacterium for humans. Therefore, controlling and inhibiting the population of lactic acid bacteria is an effective way of ensuring food safety and preservation.

Ferulic acid is a phenolic phytochemical found in plant cell walls, covalently bonded as side chains to molecules such as arabinoxylans.

WO 2008/104417 relates to a method for preserving a food composition comprising providing a food composition comprising an anionic polymer; mixing said food composition with a preservative system comprising:
(a) 20 ppm to 200 ppm of said food composition of a cationic saturated preservative having an overall positive charge;
(b) optionally, from 0.015 percent to 0.500 percent by weight of said food composition of a second preservative component;
   wherein said saturated preservative having an overall positive charge is added to the food composition in the last mixing step; thereby rendering said food composition microbiologically safe and stable.

JP2013128415 relates to a food preservative having bacteriostatic effect. The preservative composition comprises phytic acid combined with another organic acid.

JP5168449 relates to preservative compositions containing a combination of ferulic acid and organic acid.

US 2006/222746 describes a preservative composition for a food composition comprising:
(a) a first component suitable to interfere with the permeability of a cell membrane of a spoilage organism and a pathogen;
(b) a second component suitable to diffuse into the plasma of the spoilage organism and pathogen in order to kill and/or inhibit growth of the spoilage organism, pathogen or both.
   The first component can be an antibiotic, chelating agent, aromatic preservative, ester, enzyme, or a mixture thereof. The second component can be sorbic, formic, acetic, propanoic, 2-hydroxypropanoic, butyric, valeric, adipic, gluconic, malic, fumaric, citric, tartaric, ascorbic, salicylcic, or camosic acid or a mixture thereof.

WO 2021/107878 describes a film-forming composition comprising:
a hydrogel comprised of a polysaccharide; and
a water-soluble additive comprising a phenolic phytochemical and an anti-fungal agent.

CN 108 639 564 describes a method for preparing an edible composite film, which is characterized in that it comprises the following steps:
add chitosan to acetic acid solution, add plasticizer and mix well, add ferulic acid after oxidation treatment, continue to add active material, mix and stir to obtain chitosan film liquid;
add sodium alginate to deionized water, continue to add plasticizer, mix and stir to obtain sodium alginate membrane solution;
coat the sodium alginate film solution onto a plexiglass plate to cast into a film, dry it to form a sodium alginate film;
coat the chitosan film solution onto the sodium alginate film;
dry to produce an edible composite film.

### SUMMARY OF THE INVENTION

The inventors have found that bacterial spoilage of food products can be delayed very effectively by using a combination of (i) ferulic acid component selected from ferulic acid, ferulate and combinations thereof; and (ii) organic acid component being selected from acetic acid, acetate, lactic acid, lactate, propionic acid, propionate and combinations thereof. In accordance with the present invention the ferulic acid component and organic acid component are applied in carefully balanced concentrations. To achieve satisfactory preservation, the combination of ferulic acid component and organic acid component may be homogeneously distributed throughout a food product or it may be applied onto the surface of the product. The latter option is particularly suitable for food products whose interior is sterile.

Accordingly, the present invention provides a preserved food product comprising a ferulic acid component and an organic acid component in a molar ratio of at least 0.1, the ferulic acid component being selected from ferulic acid, ferulate and combinations thereof; and the organic acid component being selected from acetic acid, acetate, lactic acid, lactate, propionic acid, propionate and combinations thereof; wherein
(i) the ferulic acid component and the organic acid component are homogeneously distributed throughout the preserved food product and said food product contains per kg of food product 3.6-75 mmol of the ferulic acid component and 10-200 mmol/kg of the organic acid component; or
(ii) the surface of the food product contains 3.6-75 mmol per kg of the ferulic acid component and 10-200 mmol per kg of the organic acid component, the surface of the food product being defined as the outside layer of the food product having a thickness of 0.5 mm.

The invention further provides a method of preparing the aforementioned preserved food product, said method comprising addition of:
a ferulic acid component selected from ferulic acid, ferulate and combinations thereof; and
an organic acid component selected from acetic acid, acetate, lactic acid, lactate, propionic acid, propionate and combinations thereof;
   wherein the ferulic acid component and the organic acid component are added in a molar ratio of at least 0.1; and
   wherein (i) the ferulic acid component and the organic acid component are homogeneously distributed throughout the food product by mixing the ferulic acid component and the organic acid component with other ingredients of the food product or by injecting the ferulic acid component and the organic acid component into the food product or (ii) the ferulic acid component and the organic acid component are applied onto the surface of the food product.

Also provided is the use of a preservative composition for preserving food products, said preservative composition comprising 0.18-4.2 mmol per gram of dry matter a ferulic acid component selected from ferulic acid, ferulate and combinations thereof; and 0.59.0 mmol per gram of dry matter of an organic acid component selected from acetic acid, acetate, lactic acid, lactate, propionic acid, propionate and combinations thereof.

### DETAILED DESCRIPTION OF THE INVENTION

A first aspect of the invention concerns a preserved food product comprising a ferulic acid component and an organic acid component in a molar ratio of at least 0.1, the ferulic acid component being selected from ferulic acid, ferulate and combinations thereof; and the organic acid component being selected from acetic acid, acetate, lactic acid, lactate, propionic acid, propionate and combinations thereof; wherein
(i) the ferulic acid component and the organic acid component are homogeneously distributed throughout the preserved food product and said food product contains per kg of food product 3.6-75 mmol of the ferulic acid component and 10-200 mmol/kg of the organic acid component; or
(ii) the surface of the food product contains 3.6-75 mmol per kg of the ferulic acid component and 10-200 mmol per kg of the organic acid component, the surface of the food product being defined as the outside layer of the food product having a thickness of 0.5 mm.

The benefits of the present invention are particularly appreciated in food products that contain a substantial amount of water. Preferably, the food product comprises 30-95 wt. % water. More preferably, the food product has a water content in the range of 50-80% by weight of the food product.

The water activity of the food product at 20° C. is preferably between 0.90 and 0.995, more preferably between 0.93 and 0.99, most preferably between 0.95 and 0.985.

The food product preferably has a pH at 20° C. in the range of pH 3 to pH 7.5, more preferably in the range of 3.5 to 6.5

Examples of food products that can be preserved effectively in accordance with the present invention include meat products, dairy products, bakery products, ready-to-eat (RTE) meals and salads, soups, sauces and dressings.

Food products that may suitably be preserved by distributing the combination of ferulic acid component and organic acid component homogeneously throughout the product include processed meat products, desserts, RTE meals and salads, soups, sauces and dressings.

Food products that may suitably be preserved by applying the combination of ferulic acid component and organic acid component on the surface of the product include meat, cheese and baked farinaceous products.

According to a particularly preferred embodiment, the food product is a processed meat product or meat. The meat of the food product is preferably obtained from fish, crustacean, poultry and/or livestock meat.

The benefits of the present invention can be realised both in food products that are stored at ambient temperature and food products that are stored in a refrigerator (refrigerated food products). Preferably, the food product of the present invention is a refrigerated food product.

The food product of the present invention may be cooked or uncooked. Preferably the food product is cooked. Here the term “cooked” means that the food product has undergone a heat treatment such as, for example, boiling, oven baking, frying or micro-wave heating.

According to another preferred embodiment, the food product of the invention is a non-fermented food product.

Preferably, the food product contains at least 5 mmol/kg of the homogeneously ferulic acid component; or the surface of the food product contains at least 5 mmol/kg of the ferulic acid component. More preferably the food product contains at least 8 mmol/kg of the homogeneously distributed ferulic acid component; or the surface of the food product contains at least 8 mmol/kg of the ferulic acid component. Even more preferably the food product contains at least 10 mmol/kg of the homogeneously distributed ferulic acid component; or the surface of the food product contains at least 10 mmol/kg of the ferulic acid component.

Preferably, the ferulic acid component is selected from ferulic acid, sodium ferulate, potassium ferulate and combinations thereof. More preferably, the ferulic acid component is selected from ferulic acid, sodium ferulate and combinations thereof. Most preferably, the ferulic acid component is ferulic acid.

The ferulic acid component may be provided in the preserved food product of the present invention as an essentially pure substance and/or in the form of an ingredient containing the ferulic acid component. According to a preferred embodiment, the ferulic acid component is provided in the from a plant-derived material and/or an extract of such a plant-derived material.

Examples or ingredients that can be employed as a source of the ferulic acid component include grains extracts (e.g. extracts of rice, rye, barley, wheat, oats and/or corn); spice extracts (e.g. extracts of clove, thyme, sage, basil and/or marjoram; fruit extracts (e.g. extracts of pineapple, banana, orange, grapes, grape seeds, dates and/or grapefruit); coffee and/or coffee extract; cocoa beans and/or cocoa bean extract; vegetables and/or extracts of vegetables (e.g. tomato, carrot, beetroot, parsnip, broccoli, cabbage and/or eggplant, or extracts thereof); legumes and/or extracts of legumes (e.g. beans, soybeans, peas, chickpeas, peanuts, lentils, lupins, mesquite, carob, tamarind and/or alfalfa, or extracts thereof); leafy greens and/or extracts thereof (e.g. lettuce and/or spinach, or extracts thereof); bamboo, including bamboo sprouts, and/or extracts thereof; and walnuts and/or extracts thereof. Naturally, these ingredients may also be employed in combination.

Use of the aforementioned plant-derived ingredients as a source of the ferulic acid component is preferred because of their positive impact on organoleptics (colour, taste, odour, appearance, texture).

According to a preferred embodiment, the ingredient containing the ferulic acid that is employed in the preserved food product contains at least 0.5 mol of the ferulic acid component per kg of dry matter, more preferably at least 1 mol of the ferulic acid component per kg of dry matter, and most preferably 1.5-4.2 mmol of the ferulic acid component per kg of dry matter.

According to a preferred embodiment, the food product contains at least 20 mmol/kg of the homogeneously distributed organic acid component; or the surface of the food product contains at least 20 mmol/kg of the organic acid component. More preferably the food product contains at least 30 mmol/kg of the homogeneously distributed organic acid; or the surface of the food product contains at least 30 mmol/kg of the organic acid component.

Preferably, the ferulic acid component and the organic acid component are present in the food product in a molar ratio of 0.12-7.5, more preferably 0.15-5, most preferably of 0.2-2. Preferably, the organic acid component is selected from acetic acid, acetate, lactic acid, lactate and combinations thereof. More preferably the organic acid component is selected from lactic acid, lactate and combinations thereof.

The lactate is preferably selected from sodium lactate, calcium lactate, potassium lactate and combinations thereof. More preferably the lactate is sodium lactate.

The acetate is preferably selected from sodium acetate, potassium acetate, sodium diacetate, potassium diacetate, calcium acetate and combinations thereof. More preferably the acetate is selected from sodium acetate, sodium diacetate and combinations thereof.

The propionate is preferably selected from sodium propionate, potassium propionate, calcium propionate and combinations thereof. More preferably the propionate is sodium propionate.

Preferably, the organic acid component is selected from lactate, acetate, propionate and combinations thereof. More preferably the organic acid component is selected from lactate, acetate and combinations thereof.

According to a particularly preferred embodiment, the organic acid component comprises lactate and acetate. More preferably the organic acid component comprises sodium lactate and acetate selected from sodium acetate, sodium diacetate and combinations thereof.

Preferably, lactate and acetate are present in the food product in a molar ratio of 2:1 to 10:1, more preferably of 1:1 to 1:5, most preferably of 1:1.5 to 1:4.

Another aspect of the invention relates to a method of preparing a preserved food product according to the invention, said method comprising addition of:
a ferulic acid component selected from ferulic acid, ferulate and combinations thereof; and
an organic acid component selected from acetic acid, acetate, lactic acid, lactate, propionic acid, propionate and combinations thereof;
   wherein the ferulic acid component and the organic acid component are added in a molar ratio of at least 0.1; and
   wherein (i) the ferulic acid component and the organic acid component are homogeneously distributed throughout the food product by mixing with other ingredients of the food product or by injecting the ferulic acid component and the organic acid component into the food product or (ii) the ferulic acid component and the organic acid component are applied onto the surface of the food product.

According to a particularly preferred embodiment, the ferulic acid component and the organic acid component are added in the form of a preservative composition containing both the ferulic acid component and the organic acid component.

The preservative composition that can be employed in the present method preferably comprises 0.18-4.2 mmol per gram of dry matter, more preferably 0.25-3.5 mmol per gram of dry matter and most preferably 0.3-3.0 mmol per gram of dry matter of the ferulic acid component.

The ferulic acid component may be provided in the present method as an essentially pure substance and/or in the form of an ingredient containing the ferulic acid component. According to a preferred embodiment, the ferulic acid component is provided in the from a plant-derived material and/or an extract of such a plant-derived material.

Examples or ingredients that can be employed as a source of the ferulic acid component include grains extracts (e.g. extracts of rice, rye, barley, wheat, oats and/or corn); spice extracts (e.g. extracts of clove, thyme, sage, basil and/or marjoram; fruit extracts (e.g. extracts of pineapple, banana, orange, grapes, grape seeds, dates and/or grapefruit); coffee and/or coffee extract; cocoa beans and/or cocoa bean extract; vegetables and/or extracts of vegetables (e.g. tomato, carrot, beetroot, parsnip, broccoli, cabbage and/or eggplant, or extracts thereof); legumes and/or extracts of legumes (e.g. beans, soybeans, peas, chickpeas, peanuts, lentils, lupins, mesquite, carob, tamarind and/or alfalfa, or extracts thereof); leafy greens and/or extracts thereof (e.g. lettuce and/or spinach, or extracts thereof); bamboo, including bamboo sprouts, and/or extracts thereof; and walnuts and/or extracts thereof. Naturally, these ingredients may also be employed in combination.

As already mentioned above, the use of the aforementioned plant-derived ingredients as a source of the ferulic acid component is preferred because of their positive impact on organoleptics (colour, taste, odour, appearance, texture).

According to a preferred embodiment, the ingredient containing the ferulic acid that is employed in the present method contains at least 0.5 mol of the ferulic acid component per kg of dry matter, more preferably at least 1 mol of the ferulic acid component per kg of dry matter, and most preferably 1.5-4.2 mol of the ferulic acid component per kg of dry matter.

The preservative composition preferably contains 0.5-9.0 mmol per gram of dry matter, more preferably 1.5-8.5 mmol per gram of dry matter and most preferably 2.6-8.0 mmol per gram of dry matter of the organic acid component.

Preferably, the combination of the ferulic acid component and the organic acid component constitutes 30-100 wt. % of the dry matter that is contained in the preservative composition. More preferably said combination constitutes between 40-100 wt. % of the dry matter contained in the preservative composition.

According to a preferred embodiment, the preservative composition is in the form of a powder or an aqueous solution. More preferably, the preservative composition is in the form of a powder.

The preservative composition in powder form is preferably dissolved in aqueous liquid prior to addition to the food product. The resulting aqueous liquid preferably contains 5.4-1,260 mmol/l of the ferulic acid component and 15-2,700 mmol/l of the organic acid component. More preferably, 7.5-1,050 mmol/l of the ferulic acid component and 45-2,550 mmol/l of the organic acid component.

According to another preferred the food product that is preserved by the present method is a refrigerated food product. Preferably the preserved refrigerated food product is kept refrigerated for at least 3 days. Storage under refrigeration is preferably at a temperature below 10° C., more preferably at a temperature between 0° C. and 8° C., most preferably at a temperature between 2° C. and 5° C.

In the present method the preservative composition can suitably be applied onto the surface of the food product by spraying or sprinkling the preservative composition onto the food product, by immersing or pressing the food product into the preservative composition or by passing the food product through a falling curtain of the preservative composition.

Yet another aspect of the invention relates to the use of a preservative composition for preserving food products, wherein the preservative composition is a preservative composition as described above.

In one embodiment, the use of preservative composition comprises mixing of the preservative composition with other ingredients of the food product.

In another embodiment, the use comprises injecting the preservative composition into the food product.

In yet another embodiment, the use comprises applying the preservative composition onto the surface of the food product. Suitable techniques for applying the preservative composition onto the surface of the food product are described above.

Preferably, the preservative composition is applied in or on the food product to produce a preserved food product and the preserved food product is kept at a temperature below 7° C. after application of the preservative composition.

The invention is further illustrated by the following non-limiting examples.

### EXAMPLES

### Example 1

Ferulic acid extract (98% purity, Tsuno, Japan), sodium lactate powder (PURASAL Powder S100, 95% sodium lactate), sodium acetate and/or sodium diacetate were dissolved in water, together with NaCl and sugar, to formulate a brine which was subsequently added to chicken meat pieces (18%), followed by tumbling for 1 hour at 1-2° C.

Next, the meat pieces were cooked in an industrial steam cooker (72° C. core temperature), cooled down and inoculated with 3 Log CFU/g of a bacterial cocktail (Leuconostoc mesenteroides, Lactobacillus sakei, and Leuconostoc carnosum).

The inoculated samples were kept at 7° C. for the entire length of the challenge study and bacterial counts were determined at different time intervals. Results were expressed as the number of days after which the spoilage threshold TTG5 (5 Log CFU/g outgrowth) was reached. In this case, 5 Log CFU/G outgrowth means that the bacterial population reached 8 Log CFU/g. TTG5 was calculated using the Baranyi and Roberts model (Baranyi and Roberts, A dynamic approach to predicting bacterial growth in food. Int. J. Food Microbiol. (1994), 23, 277-294) to fit curves with growth data by linear and nonlinear regression.

Table 1 shows the concentrations of ferulic acid and sodium lactate in the brines and the TTG5 of the meat samples that had been treated with these brines.

TABLE 1

| | Wt. % | | | | |
|---|---|---|---|---|---|
| | Ferulic | Sodium | Sodium | Sodium | TTG5 |
| | acid | lactate | acetate | diacetate | (in days) |
| Control | 0 | 0 | 0 | 0 | 6.0 |
| A | 0.2 | 0 | 0 | 0 | 8.5 |
| B1 | 0 | 0.5 | 0 | 0 | 5.4 |
| B2 | 0 | 0.2 | 0.2 | 0.1 | 6.2 |
| 1 | 0.2 | 0.5 | 0 | 0 | 9.0 |
| 2 | 0.2 | 0.2 | 0.2 | 0.1 | 9.6 |

### Example 2

Example 1 was repeated, except that this time other sources of ferulic acid (rice bran extract containing appr. 50 wt. % ferulic acid, Blue California, US) and sodium lactate (PURASAL Powder S100, 95% sodium lactate) were used, and in that added amount of sodium lactate was increased from 0.5 wt. % to 1.2 wt. %.

The results obtained are summarized in Table 2.

TABLE 2

| | Ferulic acid | Sodium lactate | TTG5 |
|---|---|---|---|
| | (in wt. %) | (in wt. %) | (in days) |
| Control | 0 | 0 | 6 |
| A | 0.2 | 0 | 11 |
| B | 0 | 1.2 | 6 |
| 1 | 0.2 | 1.2 | 19 |

### Example 3

An experiment was conducted to determine the effect of different antimicrobial compositions on the growth rates of three different LAB strains (Leuconostoc mesenteroides, Lactobacillus sakei, and Leuconostoc carnosum) after inoculation of Brain Heart Infusion (BHI) broth.

The BHI broth used in the experiment was prepared by dissolving BHI powder in distilled water (37 g/L).

The test solutions were prepared by adding the antimicrobial components (ferulic acid, sodium lactate, sodium acetate and/or sodium propionate) to the broth, adjusting pH to 6.5 using 5M HCL or 5M NaOH solution, followed by filter sterilization (0.2 uM filter).

The bacterial inoculums were prepared as follows:
each individual culture was revived from a −80 C glycerol stock by streaking a small volume from the stock onto the surface of BHI agar Petri dish;
the dish was incubated for 18-24 hours at 37° C.;
a single colony was transferred from the BHI agar surface to 9 ml sterile BHI broth, followed by incubation for 18-24 hours at 30° C.

Different concentrations of antimicrobial component were added to the test suspension in a Bioscreen plate filled with broth. Each well was inoculated with a micro-organism (3 log CFU/mL) in each well and the Bioscreen plate was incubated in the Bioscreen C device at 30° C. The optical density (OD) of each well was measured automatically every 20 minutes at 420-580 nm. The plates were moderately shaken for 5 seconds before each measurement to prevent false OD reading. The OD values were used to prepare a growth curve for each combination of micro-organism and antimicrobial component. Growth rate (Mu) was determined only for the exponential interval of the growth curve by using GrowthFit 3 tool;

In Table 3 the concentration levels of the antimicrobials used and the effect on growth of Leuconostoc mesenteroides, Lactobacillus sakei, and Leuconostoc carnosum are reported.

TABLE 3

| | Wt. % | | | | | | |
|---|---|---|---|---|---|---|---|
| | Ferulic | Sodium | Sodium | Sodium | Mu (1/h) | | |
| | acid | lactate | acetate | proprionate | L. sakei | L. mesent. | L. carnosum |
| Control | — | — | — | — | 0.240 | 0.122 | 0.133 |
| 1 | 0.5 | — | — | — | 0.067 | 0.036 | 0.031 |
| 2 | 0.5 | 1.5 | — | — | 0.045 | 0.020 | 0.007 |
| 3 | 0.5 | — | 0.9 | — | 0.065 | 0.017 | 0.017 |
| 4 | 0.1 | — | — | — | 0.179 | 0.127 | 0.092 |
| 5 | 0.1 | 1.5 | — | — | 0.169 | 0.105 | 0.097 |
| 6 | 0.1 | — | — | 0.3 | 0.168 | 0.113 | 0.096 |

1. A preserved food product comprising a ferulic acid component and an organic acid component in a molar ratio of at least 0.1, the ferulic acid component being selected from ferulic acid, ferulate and combinations thereof; and the organic acid component being selected from acetic acid, acetate, lactic acid, lactate, propionic acid, propionate and combinations thereof; wherein
(i) the ferulic acid component and the organic acid component are homogeneously distributed throughout the preserved food product and the food product comprises per kg of food product 8-75 mmol of the ferulic acid component and 10-200 mmol/kg of the organic acid component; or
(ii) the surface of the food product comprises 8-75 mmol per kg of the ferulic acid component and 10-200 mmol per kg of the organic acid component, the surface of the food product being defined as the outside layer of the food product having a thickness of 0.5 mm.

2. The food product according to claim 1, wherein the food product comprises 30-95 wt. % water.

3. The food product according to claim 1, wherein the food product has a water activity between 0.90-0.995.

4. The food product according to claim 1, wherein the ferulic acid component and the organic acid component are homogeneously distributed throughout the food product and wherein the food product is selected from processed meat products, desserts, ready-to-eat meals and salads, soups, sauces and dressings.

5. The food product according to claim 1, wherein the surface of the food product comprises 8-75 mmol per kg of the ferulic acid component and 10-200 mmol per kg of the organic acid component and wherein the food product is selected from meat, cheese and baked farinaceous products.

6. The food product according to claim 1, wherein:
(i) the food product comprises at least 10 mmol/kg of the homogeneously distributed ferulic acid component; or
(ii) the surface of the food product comprises at least 10 mmol/kg of the ferulic acid component.

7. The food product according to claim 1, wherein:
(i) the food product comprises at least 20 mmol/kg of the homogeneously distributed organic acid component; or
(ii) the surface of the food product comprises at least 20 mmol/kg of the organic acid component.

8. The food product according to claim 1, wherein the food product comprises the ferulic acid component and the organic acid components in a molar ratio of 0.12 to 7.5.

9. The food product according to claim 1, wherein the organic acid component is selected from lactic acid, lactate and combinations thereof.

10. A method of preparing a preserved food product according to claim 1, the method comprising adding:
(a) a ferulic acid component selected from ferulic acid, ferulate and combinations thereof; and
(b) an organic acid component selected from acetic acid, acetate, lactic acid, lactate, propionic acid, propionate and combinations thereof;
wherein the ferulic acid component and the organic acid component are added in a molar ratio of at least 0.1; and
wherein (i) the ferulic acid component and the organic acid component are homogeneously distributed throughout the food product by mixing the ferulic acid component and the organic acid component with other ingredients of the food product or by injecting the ferulic acid component and the organic acid component into the food product or (ii) the ferulic acid component and the organic acid component are applied onto the surface of the food product.

11. The method according to claim 10, wherein the ferulic acid component and the organic acid component are added in the form of a preservative composition comprising 0.18-4.2 mmol per gram of dry matter of the ferulic acid component and 0.5-9.0 mmol per gram of dry matter of the organic acid component.

12. The method according to claim 11, wherein the preservative composition is added in the form of a powder or an aqueous solution.

13. The method according to claim 11, wherein the preservative composition is an aqueous solution comprising 5.4-1,260 mmol/l of the ferulic acid component and 15-2,700 mmol/l of the organic acid component.
